(19) United States
(12) Patent Application Publication
(10) Pub. No.: US 2004/0015268 A1
(43) Pub. Date: Jan. 22, 2004

(54) Display and control unit, variety management apparatus, relay communication apparatus, communication device, and broadcast system

(76) Inventors: Hiroyuki Kato, Tokyo (JP); Ryoichi Mitaku, Tokyo (JP); Hidefumi Harada, Tokyo (JP); Yoshihiro Miyajima, Tokyo (JP); Hirofumi Hirayama, Tokyo (JP)

Correspondence Address: ROTHWELL, FIGG, ERNST & MANBECK, P.C., 1425 K STREET, N.W., SUITE 800, WASHINGTON, DC, 20005, US

(21) Appl. No.: 10/362,998

(22) PCT Filed: Sep. 27, 2001
(86) PCT No.: PCT/JP01/08460

(30) Foreign Application Priority Data
Sep. 29, 2000 (JP) 2000-300947
Sep. 29, 2000 (JP) 2000-300958
Sep. 29, 2000 (JP) 2000-300966
Sep. 29, 2000 (JP) 2000-300969

(51) Int. Cl. G01M 1/38

(52) U.S. Cl. 700/275; 700/17

(57) ABSTRACT

A display and control unit has a first communication means for communicating with individual controllers 9 corresponding to plural object control sections 31, a controller selection means 241 for selecting a target individual controller, a LED address display means 231 for displaying a place of the target individual controller, LED state display means 234, 235 for displaying a current state of the object control section, a mode switch means 243 for switching a current state mode, a set state mode, and a display mode, and state set means 245 and 246 for sending set data to the individual controllers during the data set mode.

A display and control unit has a first communication means 25 for communicating with individual controllers 9 corresponding to plural object control sections 31, a controller selection means 241 for selecting a target individual controller, a LED address display means 231 for displaying a place of the target individual controller, LED state display means 234, 235 for displaying a current state of the object control section, a mode switch means 243 for switching a current state mode, a set state mode, and a display mode, and state set means 245 and 246 for sending set data to the individual controllers during the data set mode.

### TECHNICAL FIELD

The present invention relates to a display and control unit, a product type management apparatus, a communication relay device, a communication device, and a broadcasting communication system for remotely setting and controlling the states such as temperatures and humidity of a plurality of object control sections in a manufacture apparatus such as a furnace and an oven.

### BACKGROUND ART

FIG. 1 and FIG. 2 are diagrams showing examples of using a conventional display unit and controllers.

In FIG. 1, reference number 1 designates a furnace, and 2 denotes a plurality of object control sections, namely, plural detection positions through which the internal temperature of the furnace is set and detected. Reference number 3 indicates a control panel, 4 designates a display unit, and 5 denotes an operation section through which the temperature for each object control section 2 is set.

The control panel 3 placed at only one location incorporates a controller. Because the display unit 4 displays all of the temperatures of the object control sections 2 simultaneously, an operator may monitor the states of the object control sections 2. The operator may change and set the temperature value of each control position 2 through the operation section 5. Therefore the control panel 3 has a large panel in size.

In FIG. 2, reference number 6 designates a furnace for soldering and heating an object heat material 10 such as a printed substrate. Reference number 7 denotes each object control section in which a heater is placed. Reference number 8 indicates a display unit for displaying the temperature of each object control section 7. Reference number 9 designates an individual controller which is placed corresponding to each object control section 7.

The object heat material 10 is inserted from the inlet 11 of the furnace 6 and removed through the outlet 12 of the furnace 6. In the process of transmitting the object heat material 10 through each control section 7 in the furnace 6, the object heat material 10 is heated at a desired temperature set to each control section 7. Through the display unit 8 placed at one location, the operator may monitor the current temperature (as a current state) of each object control section 7.

Each individual controller 9 detects the temperature and transfers the temperature data detected to the display unit 8 through a communication network 13. At present, a liquid crystal display unit and a LED display unit are mostly used in the display unit 8. FIG. 3 and FIG. 4 show block diagrams of conventional systems in which controllers and a display unit are combined.

In FIG. 3, reference number 14 designates a liquid crystal display unit which reads the current temperatures (as the current states) of the object control sections by a plurality of the individual controllers 9 and receives the detected data through the communication network 13. The display unit 14 then displays on a large screen the detected data such as the temperature in numeric form or in graph by a screen display program that has been developed in advance.

In FIG. 4, reference number 15 designates a LED display unit for reading detected data representing the state of the object control section from a plurality of the individual controllers 9, and receives electric signals obtained by converting the detected data in current or voltage form through a corresponding individual transmission wiring 16. In this case, the LED display unit 15 converts the received electric signals to the original data by a conversion operation and displays the converted data. The LED display unit 15 is divided into a plurality of individual display blocks, each of which corresponds to each object control section which also corresponds to each individual controller. Each individual display block displays the detected temperature of the corresponding object control section.

FIG. 5 is a block diagram showing a system configuration of a conventional product type data management apparatus. In the diagram, reference number 51 designates a product type data management apparatus for centrally controlling product type data which are different every product type to be set in the individual controllers for controlling the product manufacturing device manufacturing the product. Reference number 52 indicates a display means such as a display unit connected to the product type data management apparatus 51, 53 denotes an input means such as a keyboard. Reference numbers 54, 55, . . . , and 56 designate individual controllers for controlling the temperature of each part in an oven in a food making apparatus for making foods such as a bread, for example. Reference number 57 designates a communication line connected between the product type data management apparatus 51 and the individual controllers 54, 55, . . . , and 56.

Next, a description will now be given of the operation of the conventional product type data management apparatus shown in FIG. 5.

In the product type data management apparatus, the product type data are set into each of the individual controllers 54, 55, . . . , and 56, for example, according to the type of bread to be made by the oven in the food making apparatus. In this case, the product type is a type of bread, such as white bread, crumb bun, croissant (crescent roll), and so on. The product type data are P (Proportion) value, I (Integral) value, and D (Differential) value to be set in each of the individual controller 54, 55, . . . , and 56 according to the type of bread in the automatic temperature control of the oven.

The product data to be set into each of the individual controller 54, 55, . . . , and 56 have been set in the product type data management apparatus 51 in advance. In a case where the type of bread to be baked is croissant, when the operator specifies a product type number corresponding to the croissant, the product type data for the croissant are read from the product type data management apparatus 51, and transferred to each individual controller 54, 55, . . . , and 56 simultaneously through the communication line 57. Each of optimum values P (Proportion), I (Integral), and D (Differential) is determined by auto-tuning by executing the temperature control for the oven according to the type of bread, and the optimum values P, I, and D are set in each individual controller 54, 55, . . . , and 56, although there is a case where a skilled operator determines the optimum values P, I, and D based on the operator's experience and sets them through the keyboard into the product type data management apparatus 51.

Upon determining the product type data by the auto-tuning and setting them to each individual controller 54, 55, . . . , and 56, the display unit in each individual controller displays the product type data determined at first. The operator then reads the product type data through the display unit in each individual controller, and inputs again the data as the product type data for each individual controller through the input means 53 in the product type data management apparatus 51. The data inputted is transferred to and stored in the product type data management apparatus 51.

FIG. 6 is a block diagram showing a configuration of a conventional communication system composed of an upper communication device and lower communication devices. In the diagram, reference number 451 designates a communication line placed in a factory, for example. Reference number 451 denotes the communication device in an upper stage as a host device. Reference numbers 453, 454, . . . , and 455 denote the communication devices in a lower stage as slave devices. The communication device 452 in the upper stage is connected to the communication devices 453, 454, . . . , and 455 through the communication line 451. The communication device 452 is made up of a personal computer having a communication function, for example. The lower communication devices 453, 454, . . . , and 455 having a communication function for communicating with the communication device 452 and controlled by the communication device 452 in the upper stage, like the individual controllers 9 that will be explained in the description for the first embodiment.

FIG. 7 shows the format of a command (a) to be transferred from the upper communication device 452 to the lower communication devices 453, 454, . . . , and 455 in one-to-one communication between the communication device 452 in the upper stage and the communication devices 453, 454, . . . , and 455 in the lower stage. FIG. 7 also shows the format of a response command (b) to be transferred from the communication devices 453, 454, and 455 in the lower stage to the communication device 452 in the upper stage.

Next, a description will now be given of the operation of the conventional communication system shown in FIG. 6.

In the communication system, the communication device 452 in the upper stage specifies the communication device in the lower stage by using the address thereof, and transfers the command (a) shown in FIG. 7 to the specified lower communication device through the communication line, for example.

When receiving the command from the communication device 452 in the upper stage, each communication device in the lower stage judges whether or not the received command is the command transferred to its own device based on the address received. When receiving the command, the lower communication device transfers the response command (b) shown in FIG. 7 to the communication device 452 in the upper stage through the communication line 451. In the manner described above, the communication between the communication device 452 and the communication devices 453, 454, . . . , and 455 is performed.

In the communication system, when setting same parameters and operation mode for the communication devices in the lower stage, at first the communication device 452 in the upper stage transfers the command (a) shown in FIG. 7 to one of the communication devices 453, 454, . . . , and 455 in the lower stage, and the communication device in the lower stage receiving the command transfers the response command (b) shown in FIG. 7 to the upper communication device 452. Upon the completion of the communication between the communication device 452 in the upper stage and the communication device in the lower stage (for example, the device 453), the communication device 452 in the upper stage further transfers the command to the following communication device in the lower stage (for example, the device 454) in order to set the same parameters and operation mode based on the same manner in the first transmission. The communication device 452 in the upper stage repeats the same operation in order to transfer the command to all the other communication devices in the lower stage.

In such a communication system, because the communication is performed sequentially between the communication device 452 in the upper stage and each of the communication devices 453, 454, . . . , and 455 in the lower stage, it takes a long time until the completion to set the command into all of the communication devices 453, 454, . . . , and 455 in the lower stage. In order to avoid this drawback, there is a conventional communication system using addresses for a broadcasting communication which is obtained by converting the actual addresses of the communication devices 453, 454, . . . , and 455 in the lower stage so that the communication device 452 in the upper stage can transfer and set the same parameters and operation mode to the communication devices 453, 454, . . . , and 455 in the lower stage simultaneously and speedily.

When the broadcasting communication is performed between the communication device 452 in the upper stage and the communication devices 453, 454, . . . , and 455 in the lower stage in such a communication system so that the communication device 452 in the upper stage sets the same parameters and operation mode to those communication devices in the lower stage, virtual addresses for the broadcasting communication are assigned to the communication devices 453, 454, . . . , and 455 in the lower stage, which are different from the actual addresses thereof. The communication device 452 in the upper stage sets those virtual addresses to the communication devices in the lower stage using the communication command. Thus, such a broadcasting communication can set the same parameters to the communication devices 453, 454, . . . , and 455 in the lower stage. However, because the communication devices in the lower stage to which the virtual addresses have been assigned do not send the response to the communication device 452 in the upper stage, it is possible to avoid any collision between the responses transferred from the communication devices 453, 454, . . . , and 455 in the lower stage on the communication line 451.

Thus, the conventional display unit and the controllers have the configuration using the control panel 3 shown in FIG. 1 described above. Although the operator can monitor and manage the entire of the control sections 2, and set and change the temperature of the control sections 2 at one position, the size of the display unit 4 becomes large and it is necessary to run individual transmission wiring through which control signals, are transferred, where those control signals are used for displaying the state between each object control section 2 and the control panel 3 and for setting the temperature value to the control sections 2. This causes that the system configuration becomes complicated.

In the case shown in FIG. 2, because the transmission of the detected data between the display unit 8 and each individual controller 9 can be performed through the communication line 13, it can avoid that the configuration of wiring becomes complicated. However, the operator must move to each individual controller 9 in order to see the display unit 8 and set and change the set temperature. When the furnace 6 is long, the operator cannot cope with an emergency. Further, upon using the liquid crystal display unit, although various states can be displayed simultaneously, it is necessary to develop programs for displaying various data items on the display unit and it takes a long development term for the programs. This causes a bad influence in reduction of the cost of the system using such a display unit.

On the other hand, because the LED display unit has only the function to display individual data that are determined in advance, does not have another function, it is therefore difficult to expand or improve the function and reduce the entire size thereof. Accordingly, it is necessary to incorporate additional LED display units (or blocks) in order to display other data.

Furthermore, when the computer of the upper state in a system hierarchy performs the central monitoring of various kinds of data, it is necessary to run additional communication lines between the computer and each individual controller 9 and to incorporate communication means for this purpose. This prevents the extension of the system.

The configuration of the conventional product data management system shown in FIG. 5 often causes input error when the operator inputs the product data items for the individual controller 54, 55, . . . , and 56 to the product type data management apparatus 51 through the input means 53. Therefore it cannot guarantee the correct registration of the product data items and it takes more time to input the product data items to the individual controllers 54, 55, . . . , and 56.

Further, it is possible to form a system using the liquid crystal display device 14 and the individual controllers 9 shown in FIG. 3, where the liquid crystal display device 14 has a communication function as a communication relay device connected to a personal computer (as the communication device in the upper stage), and the communication is performed between the personal computer and the individual controllers 9 (as the communication devices in the lower stage) through the liquid crystal display device 14, and the personal computer remotely monitors the state of each individual controller 9 (as the communication device in the lower stage) and sets data items and the operator can monitor the temperature data measured directly through the display unit in the communication relay device.

Furthermore, there is a demand where the number of the communication relay devices is increased according to the number of the individual controllers 9 (as the communication device in the lower stage). In order to achieve this demand, it is necessary to add additional transmission commands to be transferred to the address management function handling plural addresses in the communication relay device and also transferred to the individual controllers 9 by changing the program executed in the personal computer. This causes a complicated work. Furthermore, in the system incorporating the communication relay device, additional demand occurs, in which new additional functions based on the read data items transferred from the individual controllers 9 as the communication devices in the lower stage, such as a data display function, a diagnosis function for the communication devices in the lower stage, and data buffering function.

In general, because such a kind of the communication relay device uses the unique address for each individual device 9, it is necessary to change the application program used in the personal computer as the communication device in the upper stage in order to transfer the commands including the unique address and to receive the response thereof. This work to change the application program also causes additional work.

Furthermore, in the configuration of the conventional communication system shown in FIG. 6, it must be necessary to assign virtual addresses for use in the broadcasting communication instead of the actual addresses for use in the usual communication. The communication device in the upper stage 452 must transfer the communication command in order to set those virtual addresses to the communication devices 453, 454, . . . , and 455 in the lower stage. Thus, the additional work and time are necessary in the communication device 452 in the upper stage in order to set the virtual addresses for the broadcasting communication to the communication devices in the lower stage. However, this configuration involves a drawback. For example, under the situation where specific temperature controllers or all of the temperature controllers must halt the operation of their control target devices immediately when an abnormal condition occurs in a manufacture line when the lower communication devices 453, 454, . . . , and 455 are temperature controllers, it is impossible to assign new virtual addresses to those temperature controllers simultaneously in order to perform the broadcasting communication. In other word, the configuration of the conventional system cannot deal with such an abnormal condition immediately.

Moreover, in a case where the communication device 452 in the upper stage reads new data items such as control data and alarm data stored in each temperature controller and performs the broadcasting communication while monitoring the control state and the alarm state of each temperature controller, it is impossible to assign the virtual addresses promptly to the temperature controllers because it is necessary to assign the virtual addresses to the temperature controllers for performing the broadcasting communication between the communication device 452 in the upper stage and the temperature controllers in the lower stages.

Further, in the usual communication using the actual addresses, when the communication device 452 (namely, the personal computer) in the upper stage cannot receive the command by the occurrence of noise, the communication device 452 in the upper stage performs a retry process (as an abnormal process detected by a timeout monitor process) to transfer the command repeatedly to the target temperature controller. Because the temperature controllers other than the target temperature controller for the retry process must wait its operation until the completion of this retry process, and the time to set the data to the other temperature controllers is thereby delayed.

Accordingly, the present invention has been made to solve the drawback involved in the conventional controller. It is therefore an object of the present invention to provide a display and control unit using a LED display unit capable of expanding the display function without increasing any additional display area, of easily setting the state of a target device or system to be controlled by transferring or receiving various control data to or from the individual controllers, and of easily expanding the communication function for the communication device in the upper stage, and of being applicable to general-purpose applications.

Further, it is another object of the present invention to provide a product type data management apparatus capable of registering each product type data determined by each individual controller correctly and promptly.

Still furthermore, it is another object of the present invention to provide a communication relay device placed between communication devices in upper and lower stages forming an available communication system, which is capable of relaying data between those communication devices with relatively less change of the communication device in the upper stage.

Furthermore, it is another object of the present invention to provide a communication device and a broadcasting communication system capable of performing a broadcasting communication in which data can be set into a plurality of communication devices in the lower stage simultaneously while maintaining one-to-one communication between the communication devices in the upper and lower stages without any changing the inherent actual addresses assigned to the communication devices in the lower stage, and also capable of increasing the reliability in the broadcasting communication.

### DISCLOSURE OF INVENTION

A display and control unit according to the present invention has first communication means, controller selection means, LED address display means, and state display means. The first communication means is provided to each of a plurality of object control sections to be controlled and reads detected data of the current state of each object control section and controls each object control section so that this object control section is in a set state. The controller selection means selects a target individual controller in a plurality of the individual controllers. The LED address display means displays the number of the selected individual controller and the address indicating the place thereof. The state display means reads data stored in the target individual controller and displays the type of the data through the first communication means.

Thereby, the present invention has the effect that it is possible to display the current state of each object control section on a LED display unit placed in a small area by transferring the current state of each object control section by communicating with each individual controller and by switching the addresses of the individual controllers.

The display and control unit according to the present invention has channel selection means for selecting a channel, display means for displaying the channel number selected, and LED state display means corresponding to the number of the channels. The object control sections have plural state detection points. The individual controllers read detection data from the plural state detection points and have a channel function to control the set state of each detection point.

Thereby, the present invention has the effect to increase the monitoring precision because the data regarding the states of plural detection points of the object control sections can be displayed simultaneously.

The display and control unit according to the present invention has a storage means for reading the detection data of the current state of each object control section from the individual controller at a desired cycle, and for storing the data with the address display data and the set data indicating the set state of each object control section.

Thereby, the present invention has the effect that it is possible to collect the data other than the data currently displayed, to increase the response of the display, and to efficiently provide the data which a central monitor device in upper stage.

The display and control unit according to the present invention has second communication means for reading from the storage means and transmitting the address display data of the individual controllers, the detection data of the currently state, and the set data of the set state according to the request from a computer that is placed at a remote location.

Thereby, the present invention has the effect that it is possible to easily connect the display and control unit to a network, and to display the various data items of each object control section on the computer located at the distant place.

In the display and control unit according to the present invention, each individual controller has a function to set parameters of the set state in order to perform the operation per product type by a combination of the set states of the object control sections. The display and control unit further has product set data making means and product selection means. The product set data making means reads a plurality of data items by which each individual controller operates with the parameters, makes product set data for each product, and stores the product set data to the storage means. The product selection means reads the product set data from the storage means, and transfers the read one to each individual controller.

Thereby, the present invention has the effect to promptly set the recipe of each product and to improve the working efficiency of the preparation for making the desired product.

A product type management apparatus according to the present invention has product type number set means and product type data read means, and product type data storage means. The product type number set means sets the product type number corresponding to each product type. The product type data read means communicates with the individual controllers and reads the product type data of each product stored in the individual controllers. The product type data storage means stores the product type data read from the individual controllers by the product type data read means according to the product type number set by the product type number set means.

Thereby, the present invention has the effect that it is possible to register the product type data correctly and promptly because it is not necessary to read and register the product type data determined by the individual controller by manual.

The product type management apparatus according to the present invention communicates with each individual controller as a controller having an auto-tuning function, and reads the product type data including at least one of SP (Set Parameter), P(Proportional), I (Integral), and D (Differential) values from the individual controllers.

Thereby, the present invention has the effect that it is possible to register the product type data correctly and promptly because it is not necessary to read and register the product type data determined by the individual controller by manual.

A communication relay device according to the present invention has communication process means and addition function process means. When receiving communication information from a communication device in upper stage, the communication process means transmits the communication information to communication devices in lower stage without any changing it, and when receiving communication information from the communication devices in the lower stage, the communication process means transmits the communication information to the communication device in the upper stage without any changing it. When receiving the communication information transferred from the communication devices in the lower stage, the additional function process means performs an additional function based on specific information included in the communication information received.

Thereby, the present invention has the effect that it is possible to incorporate the communication relay device between the communication devices in the upper and lower stages forming an available communication system without any changing of the configuration of the communication device in the upper stage.

In the communication relay device according to another aspect of the present invention, the communication process means transmits a command to request the specific information to the communication devices in the lower stage, and the additional function process means performs the additional function process based on the response regarding the specific information from the communication devices in the lower stage received by the communication process means.

Thereby, the present invention has the effect that the communication relay device placed between the communication devices in the upper and lower stages can transfer the communication information independently to the communication devices in the lower stage and can receive the communication information as the response from the communication devices in the lower stages.

In the communication relay device according to the present invention, the additional function process means executes the additional function process to display the state of the communication devices in the lower stage included in the specific information.

Thereby, the present invention has the effect that when the communication device is placed near the object device to be controlled by the communication device in the lower stage, it is possible to monitor the state of the device to be controlled at the site.

In the communication relay device according to the present invention, the communication process means transfers the command to request the specific information to the communication device in the lower stage, and the additional function process means executes the additional function to display the state of the communication device in the lower stage included in the specific information transferred from the communication device in the lower stage received by the communication processing device.

Thereby, the present invention has the effect that when the communication device is placed near the object device to be controlled by the communication device in the lower stage, it is possible for the operator to monitor the state of the device to be controlled at the site.

In the communication relay device according to the present invention, the communication process means executes a routine process in which the communication process means transfers a command to request the specific information to a plurality of the communication devices in the lower stage in serial order and receives the response from each of them, and the communication process means interrupts the routine process in order to execute the communication process about the communication information transferred from the communication device in the upper stage when receiving this communication information to be transferred from the communication device in the upper stage to the communication devices in the lower stage.

Thereby, the present invention has the effect in which even if the communication relay device performs the routine process to transfer the information to each of the communication devices in the lower stage, the communication device in the upper stage can transfer the communication information to the communication device in the lower stage and then can promptly receive the communication information as the response transferred from this communication device in the lower stage.

A communication device as a host device according to the present invention generates a broadcasting communication command including identification information to indicate to slave communication devices that this communication is a broadcasting communication without any changing of the inherent addresses of the slave communication devices, which have been assigned in advance for use in an usual communication, and sends it to a communication network.

Thereby, the present invention has the effect that it is not necessary to change the inherent addresses of the slave communication devices in order to perform the broadcasting communication, and it is possible to perform the broadcasting communication without any changing of the inherent addresses assigned to the slave communication devices and while keeping the function of the one-to-one communication between the host and slave communication devices. It is thereby possible to keep the same data in the plural slave communication devices at the same time.

A communication device s a slave device according to the present invention judges whether or not this communication is a broadcasting communication based on identification information included in a broadcasting communication command transferred from a host communication device through a communication network, without any changing of inherent addresses of the slave communication devices, for use in an usual communication, which have been set in advance. When the judgment result indicates that this communication is the broadcasting communication, the slave communication device performs the process according to the broadcasting communication command and not sends any response to the host communication device.

Thereby, the present invention has the effect that it is not necessary to change the inherent addresses of the slave communication devices which have been set in advance. The slave communication device can deal with the broadcasting communication from the host communication device while keeping the function of one-to-one communication and without any changing of inherent addresses of the slave communication devices. It is thereby possible to keep the same data in the plural slave communication devices at the same time.

In a broadcasting communication system having a host communication device and slave communication devices according to the present invention, the host communication device generates a broadcasting communication command including identification information to inform to slave communication devices that this communication is a broadcasting communication without any changing of inherent addresses which have been assigned to the slave communication devices in advance, and transfers the generated one to the communication network. Each slave communication device judges whether or not this communication is the broadcasting communication based on the address included in the broadcasting communication command. When the judgment result indicates that this communication is the broadcasting communication, the slave communication devices performs the process according to the broadcasting communication command and not sends any response to the host communication device.

Thereby, the present invention has the effect that it is not necessary to change the inherent addresses of the slave communication devices which have been set in advance. The host communication device can perform the broadcasting communication to the slave communication devices while keeping the function of one-to-one communication between the host and slave communication devices and without any changing of the inherent addresses of the slave communication devices. It is thereby possible to set the same data into the plural slave communication devices simultaneously.

In the communication device according to the present invention, transmission means in the host communication device continuously sends a broadcasting communication command, which is generated by a broadcasting communication command generation means, to the communication network many times.

Thereby, the present invention has the effect that it is possible to increase the reliability of the broadcasting communication from the host communication device to the slave communication devices.

In the broadcasting communication system according to the present invention, transmission means in the host communication device continuously sends the broadcasting communication command, which is generated by a broadcasting communication command generation means, to the communication network plural times.

Thereby, the present invention has the effect that it is possible to increase the reliability of the broadcasting communication from the host communication device to the slave communication devices.

### BRIEF DESCRIPTION OF DRAWINGS

FIG. 1 is a perspective view showing the appearance of a system as an example to which a conventional display unit and a conventional controller is applied;

FIG. 2 is a front view showing the appearance of a system as an example to which a conventional display and conventional controllers are applied;

FIG. 3 is a block diagram showing a schematic configuration of a combination system of a conventional liquid crystal display unit and conventional controllers;

FIG. 4 is a block diagram showing a schematic configuration of a combination system having conventional LED units and conventional controllers;

FIG. 5 is a block diagram showing a configuration of a conventional product type data management system;

FIG. 6 is a block diagram showing a configuration of a conventional communication system;

FIG. 7 is a diagram showing the formats of a command and a response to be used in the conventional communication system;

FIG. 8 is a block diagram showing a schematic configuration of a display and control unit according to a first embodiment of the present invention;

FIG. 9 is a perspective view of an external view of a display and control unit according to the first embodiment of the present invention;

FIG. 10 is a block diagram showing a schematic configuration of an individual controller for communicating with the display and control unit according to the first embodiment of the present invention;

FIG. 11 is a block diagram showing a system configuration to which a product type data management apparatus of a second embodiment is applied;

FIG. 12 is a block diagram showing a configuration to which the product type data management apparatus of a second embodiment is applied;

FIG. 13 is a diagram showing the explanation of a data structure of product type data, that is stored per product type number, according to the second embodiment of the present invention;

FIG. 14 is a flow chart showing an operation of the product type data management apparatus according to the second embodiment of the present invention;

FIG. 15 is a flow chart showing an operation of the product type data management apparatus according to the second embodiment of the present invention;

FIG. 16 is a block diagram showing a configuration of a communication system to which a communication relay device of a third embodiment of the present invention is applied;

FIG. 17 is a diagram showing an access example of communication data to be sued in a communication system according to the third embodiment of the present invention;

FIG. 18 is a diagram showing a data transmission sequence of sending and receiving in the communication system according to the third embodiment of the present invention;

FIG. 19 is a block diagram showing a configuration of a broadcasting communication system according to a fourth embodiment of the present invention;

FIG. 20 is a block diagram showing a configuration of communication devices in upper and lower stages in the broadcasting communication system according to the fourth embodiment of the present invention;

FIG. 21 is a diagram showing a format of a broadcasting communication command to be used in the broadcasting communication system according to the fourth embodiment of the present invention;

FIG. 22 is a block diagram showing a configuration of a broadcasting communication system according to a fifth embodiment of the present invention; and

FIG. 23 is a diagram showing a sequence of a broadcasting communication according to the fifth embodiment of the present invention.

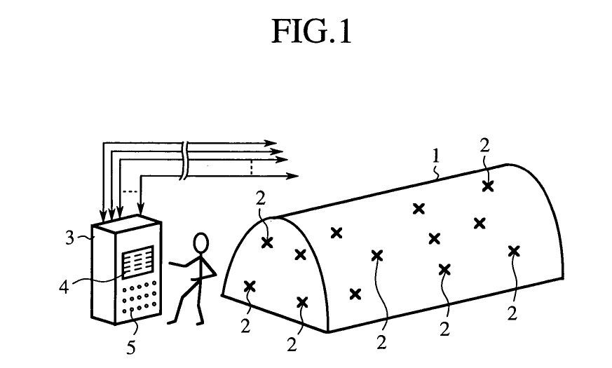

### BEST MODE FOR CARRYING OUT THE INVENTION

The best mode for carrying out the invention will now be described in detail with reference to the accompanying drawings.

First Embodiment

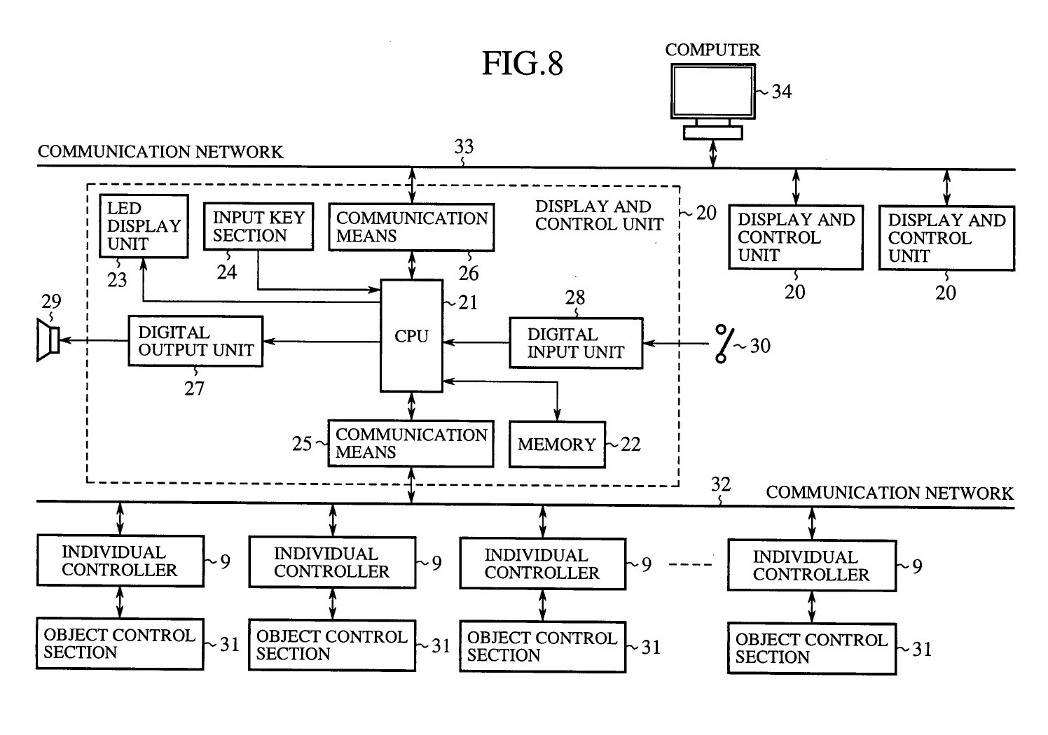

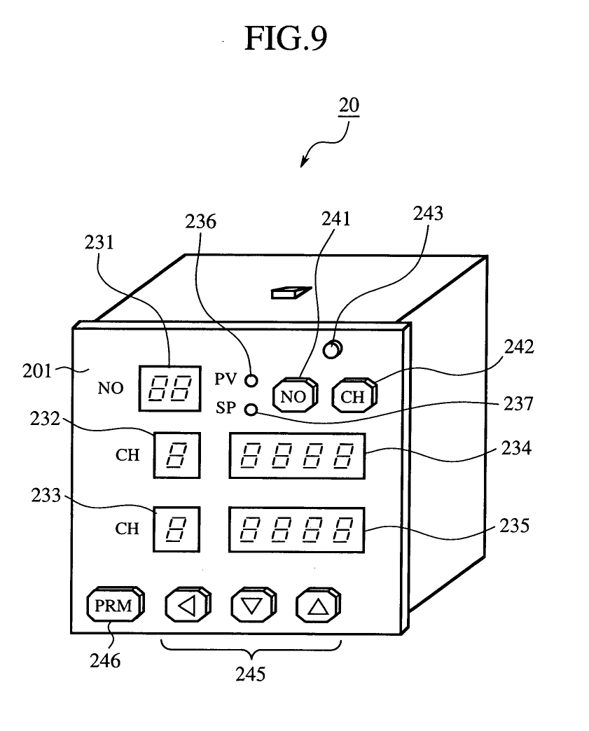

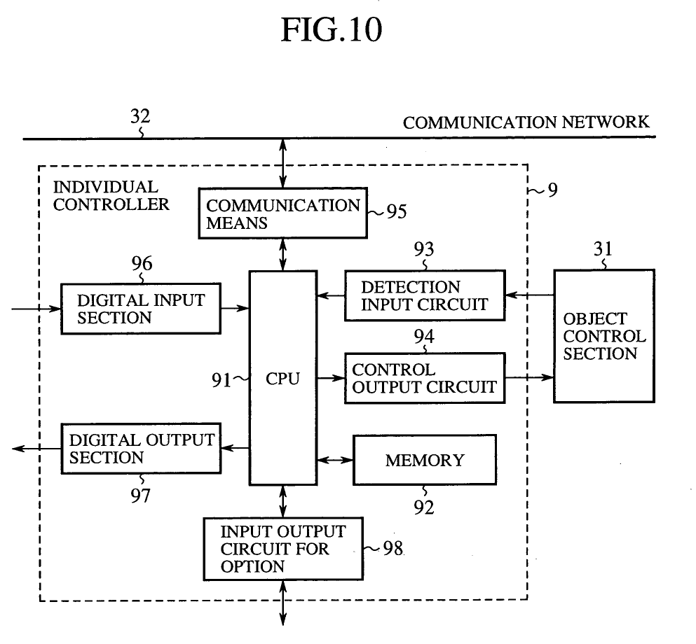

FIG. 8 is a block diagram showing a schematic configuration of a display and control unit according to a first embodiment of the present invention. FIG. 9 is a perspective view of an external view of the display and control unit. FIG. 10 is a block diagram showing a schematic configuration of an individual controller.

First, a description will be given of the individual controller to communicate data with the display and control unit of the present invention.

In FIG. 10, reference number 91 designates a central processing unit (hereinafter referred to as CPU), 92 denotes a memory, 93 indicates a detection input circuit for detecting a temperature of a object control section 31 and transfers the detected one to the CPU 91. Reference number 94 designates a control output circuit for outputting a control signal to set the temperature of the object control section 31 when receiving the instruction transferred from the CPU 91. Reference number 95 denotes a communication means to communicate with a display and control unit 20 (see FIG. 8) through a communication network 32. Reference number 96 indicates a digital input section to give control signals to halt the operation of the individual controller 9 and to use it in another application. Reference number 97 is a digital output section through which an alarm informing an abnormal state of the object control section 31 or the individual controller 9 is outputted. Further, reference number 98 designates an input output circuit for option through which a signal for storing the operation of the individual controller 97 to a recorder (not shown) and other signal is outputted.

Next, a description will be given of the operation of the individual controller 9.

The individual controller 9 placed per object control section 31 detects the temperature (current state) of the object control section 31, converts it to the detected data, and stores the detected data into the memory 92.

When receiving the read command from the display and control unit 20, the individual controller. 9 transfers the detected data to the display and control unit 20 through the communication means 95 and the communication network 32. Further, when receiving the set data to set the desired temperature through the communication means 95, the individual controller 9 stores the set data received to the memory 92, and the control output circuit 94 outputs the control signal to the object control section 31 in order to heat a heater (not shown) in the object control section 31 to the desired temperature.

It is possible to form the individual controller 9 so that it detects a plurality of points in the object control section 31. In this case, it is necessary to incorporate a plurality of the detection input output circuits 93 in the individual controller 9, and each detected data item is stored into the memory 92 every detection channel.

There is a procedure and step (common name is “recipe”) regarding baking for each product passed through a plurality of the object control sections 31. That is, there is a combination of set temperatures at a plurality of the object control sections 31. Those set temperatures are changed according to the change of the type of the product. Changing the set temperatures as the set data items causes a complicated work according to the product and the production scale. In order to solve this problem, a computer of a small size is connected to the input output circuit 98 for option and stores parameter data regarding the set temperatures for the object control section 31 into the memory 92 through the input output circuit 98. The display and control unit 20 then reads the parameter data from the memory 92, combines the parameter data with the set temperature of the object control section 31 per product, and stores the combined data as the database.

A description will now be given of the display and control unit 20 with reference to FIG. 8.

Reference number 20 designates the display and control unit, 21 denotes a CPU, 22 indicates a memory from and to which the CPU 21 reads and outputs various data. Reference number 23 indicates a LED display unit for displaying various kinds of data, and 24 designates an input key section through which the operator selects the various operations and sets various conditions. Reference number 25 denotes a communication means (as a first communication means) for performing data transmission with devices located in the lower stage to the display and control unit 20. Reference number 26 designates a communication means (as a second communication means) for performing data transmission with the computer 34 located in the upper stage to the display and control unit 20. Reference number 27 designates a digital output section for receiving an alarm signal from the CPU 21 and outputting this alarm signal to the buzzer 29 in order to drive the buzzer 29.

Reference number 28 designates a digital input section through which the CPU 21 receives various functional inputs such as the input signal to halt the individual controllers 9 in the lower stage simultaneously by turning OFF the switch 30 during the operation of the furnace. Reference number 31 designates the object control section such as the furnace and other parts whose temperature is detected and set. Reference number 9 denotes the individual controller for detecting the temperature and converting the detected one to the detected data, and for transferring the control signal to set the desired temperature to the object control section 31.

Next, a description will now be given of the operation of the display and control section 20 with reference to FIG. 9.

The operator selects one of the individual controller 9 to be controlled through the controller selection key 241 in the input key section 24.

When receiving the output from the CPU 21, the LED display unit 23 displays the address symbol indicating the number or the place of the individual controller 9 on an address display panel thereof. The CPU 21 transfers a readout command to read the detected data regarding the current temperature of the object control section to the individual controller 9.

When receiving the detected data, the CPU 21 stores it into the memory 22 and the current temperature of the object control section is displayed on the temperature (state) display panel 234 of the LED.

Through the lighting of the readout mode display lamp 236, the operator can recognize that the panel 234 is displaying the current temperature of the object.

The display and control unit 20 transfers the readout command to each individual controller 9 in a desired cycle in order to read the detected data as the current temperature and stores the received one with the address display data to the memory 22. In the memory 22, the new detected data is written onto the old detected data. The temperature display panel 234 and 235 can therefore display the current temperature read from the memory 22 without a delay.

When the temperatures of the plural points in the object control section 31 are detected, both the channel display panel 232 and 233 display the channels, and both the temperature display panels 232 and 233 display the current temperatures corresponding to both the channels.

When there are plural channels, the operator switches the channels through the channel selection key 242 in order to display the temperature of the desired channel on the state display panels 234 and 235.

The operator can change or set the temperature (state) of the object control section 31 through the mode switch key 243. When the operator uses the mode switch key 243, the current temperature readout mode display lamp 236 goes out and the set temperature (set state) mode display lamp 237 lights up. At this time, each of the temperature display panels 234 and 235 displays the set temperature. In order to change the set temperature, the operator operates the parameter selection key 245. When the operator determines the set temperature per individual controller 9 and operates the set temperature key 246, the set data are stored in the memory 22 and also transferred to each individual controller 9 in order to control the temperature of the object control section 31.

Further, the operator can operate the mode switch key 243 so that both the display lamps 236 and 237 light up. In this case, the current temperature of the selected channel is displayed on one temperature display panel 234 and set temperature of this channel is displayed on another temperature display panel 235 of the selected channel. Thus, it is possible to display plural data items on the display panels of the limited number.

The computer 34 located at a remote point is connected to the display and control unit 20 through the communication network 33. Furthermore, the computer 34 can be connected to another group made up of a combination of the object control section 31, the individual controller 9, and the display and control unit 20.

In this case, when receiving the readout command from the computer 34, the display and control unit 20 reads various data items such as the address display data, the detected data of the current temperature, and the set temperature stored in the memory 22, and transfers the read them to the computer 34 through the communication network 33. When receiving those data items, the computer 34 displays the received data items on a CRT or a liquid crystal display of a large size.

In the case where the procedure and process (recipe) regarding how to bake is changed according to the product type, the parameters as a combination of set temperatures to be set to the object control sections 31 are stored in the memory 92 in each individual controller 9 as the data obtained by auto-tuning and the like. This has been prescribed.

On the other hand, in the display and control unit 20, the product set data items per product type to operate each object control section 31 with a series of temperatures are made and stored into the memory 22.

The product set data items for the product A and the product B are selected by the signal inputted to the digital input section 28, When the product to be baked is determined, the data items for the selected product are read from each individual controller 9 and the memory 22 stores the data items combined for each product into the memory 22.

Next, for example, the product is determined by sending the signal to the digital input section 28. The operator operates the parameter selection key 245 and the set temperature key 246 in order to read the set data for the selected product from the memory 22. The data items are transferred to each individual controller 9 through the communication means 25 and then stored into the memory 92.

Each individual controller 9 reads the set temperature data, to be handled by itself, from the memory 92 and transfers the control signal to the object control section 31 through the control output circuit 94 so that the object control section 31 becomes the desired temperature. Therefore it is possible to select the product process according to the switch of the product type. This can achieve the process preparation setting work speedily and simply.

The memory 92 in the individual controller 9 stores various kinds of data items such as PID values, and the upper and lower limit values of the set temperatures. The display and control unit 20 reads those data stored in the memory 92 in the individual controller 9 and then stores them into the memory 22 and also displays them on the LED display unit 23.

In this case, the operator operates the parameter selection key 245 and the set temperature key 246 in order to display them on the temperature display panels 234 and 235. Furthermore, according to the request from the computer 34 in the upper stage, the display and control unit 20 reads those data and transfers them through the communication network for use in remote control.

As shown in FIG. 9 that is the perspective view of the display and control unit 20 according to the first embodiment, the keys of various types and the LED display panels are mounted on the operation panel 201 on which the LED display panel 23 and the input key section 24 are arranged. The total size of the display and control unit 20 is approximately equal in volume to the size of two golf balls. That is, the display and control unit 20 has a compact size. Therefore, it is not necessary to have a large area to mount it and the operator can handle it easily.

Further, it is also possible to form the individual controller 9, provided corresponding to the object control section 31, in a compact size.

As described above, according to the first embodiment, it is possible to obtain the following effects. The furnace of a large size is divided into a plurality of object control sections 31. Each individual controller 9 is placed for each object control section 31. The display and control unit 20 can display the current temperature of the object control section 31 on the LED display unit 23 by switching the address and the channel indicating each object control section.

In addition, the operator can set the set temperature of the object control section 9 through the LED display unit 23 and the input key section 24. The set temperature is transferred to the corresponding individual controller 9 in order to control it. Further, the current temperature and other data items of each object control section 31 in the lower stage are transferred to the computer 34 in the upper stage, through the communication network 33. The computer 34 can display the data items received through the communication network.

In the case where the procedure and the process (recipe) to bake the product is changed according to the product type, that it is possible to improve the efficiency of working by writing into each individual controller 9 simultaneously the product set data to combine a series of set temperatures for use in each object control section 31.

Furthermore, by combining the CPU 21 and the LED display unit 23 capable of switching the display of a plurality of data items, it is possible to provide a simple display and control unit with a compact size.

Still furthermore, because having the communication function to communicate with both the devices in the upper and lower stages, the display and control unit acts as the host device when it communicates with the individual controllers in the lower stage, and on the contrary it acts as the intermediate device when it communicates with the computer 34 in the upper stage. Thus, it is possible to switch the system configuration according to the combination of this display and control unit and other devices.

Second Embodiment

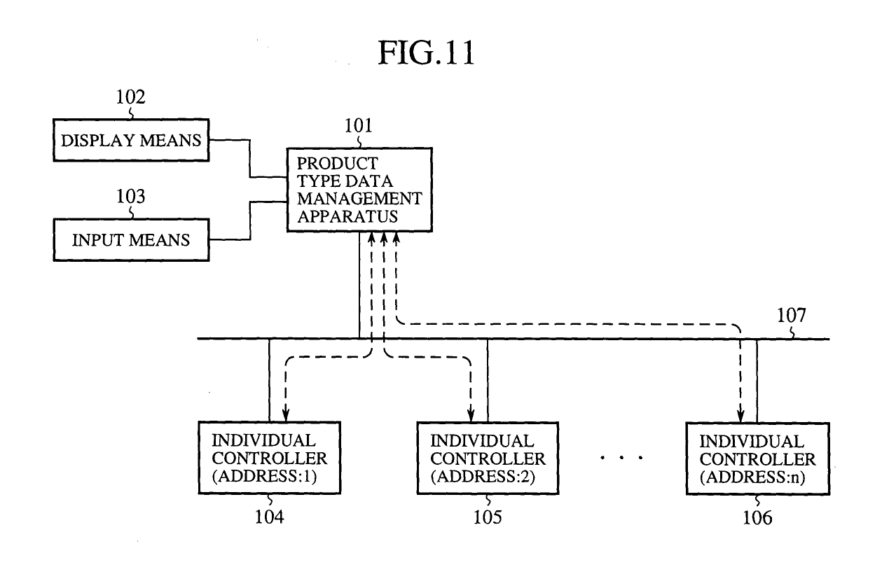

FIG. 11 is a block diagram showing a system configuration to which a product type data management apparatus of a second embodiment is applied. In FIG. 11, reference number 101 designates the product type data management apparatus to manage the product type data which are different according to the product type to be set in each individual controller for controlling the manufacture apparatus to manufacture the product. For example, the product type data management apparatus 101 manages P (Proportion) value, I (Integral) value, and D (Differential) value which are set per product type of bread in order to control the temperatures of parts in an oven for use in baking of bread. The product type data management apparatus 101 has the following functions:

Collecting the P, I, and D values per product type of bread set in each individual controller by auto-tuning, and storing those values collected; and

Setting to each individual controller those P (Proportion), I (Integral), and D (Differential) values which are set every product type of registered bread.

Reference number 102 denotes a display means such as a display connected to the product type data management apparatus 101, and 103 indicates an input means such as a keyboard. Reference numbers 104, 105, . . . , and 106, each designates the individual controller to which the inherent address is assigned. Each individual controller performs the temperature control of the corresponding part in the oven in which the bread (not shown) is baked. Each individual controller is the constant value controller having auto-tuning function. Reference number 107 denotes a communication line through which the product type data management apparatus 101 and the individual controllers 104, 105, . . . , and 106 are connected.

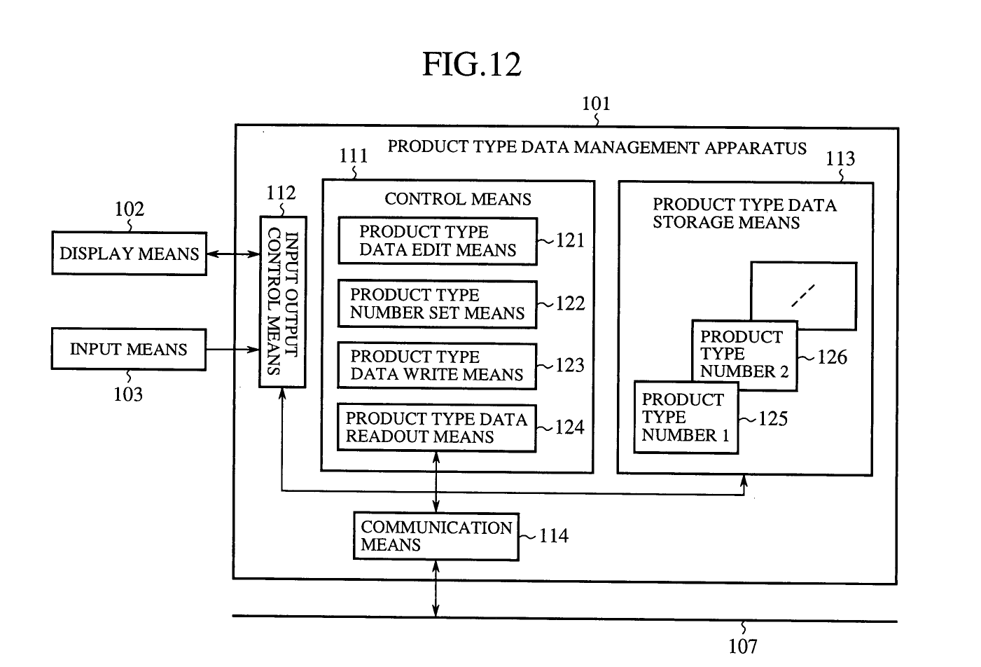

FIG. 12 is a block diagram showing a configuration of the product type data management apparatus in the product type data management system shown in FIG. 11. In FIG. 12, the same or relevant components shown in FIG. 11 are referred with the same reference numbers, and the explanation of them is omitted here. In FIG. 12, reference number 111 designates a control means including a CPU and the like, and 112 denotes an input output control means including interfaces of various types, 113 indicates a product type data storage means for storing and registering the product type data per product number which corresponds to the product type of bread. Reference number 114 designates a communication means for communicating with the individual controllers 104, 105, . . . , and 106 through the communication line 107.

Reference number 121 designates a product type data edit means for editing the product type data, 122 denotes product type number set means for setting the product type number corresponding to the product type of bread, and 123 indicates a product type data write means for outputting a write-in command to write the product type data to the individual controllers 104, 105, . . . , and 106, and for writing the product type data stored in the product type data storage means 113 to the individual controllers 104, 105, . . . , and 106 through the communication means 114.

Reference number 124 designates a product type data readout means for outputting a command to each of the individual controllers 104, 105, . . . , and 106 through the communication means 114. This command is used to read P (Proportion) value, I (Integral) value, and D (Differential) value values as each item of the product type data for use in the control of the temperature of each part in the oven adjusted by the auto-tuning by the individual controllers 104, 105, . . . , and 106. The product type data readout means 124 also reads those values such as P (Proportion) value, I (Integral) value, and D (Differential) value from the individual controllers 104, 105, . . . , and 106. Further, the product type data readout means 124 also reads the product type data 125, 126, which are stored or registered every product type number in the product type data storage means 113, when P (Proportion) value, I (Integral) value, and D (Differential) value of the product type data are set in the individual controller 104, 105, . . . , and 106.

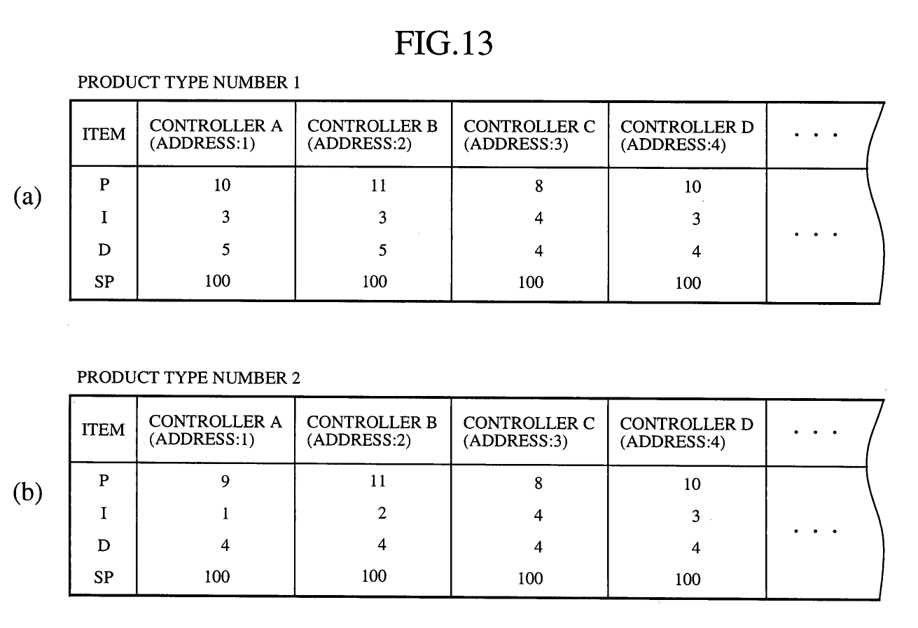

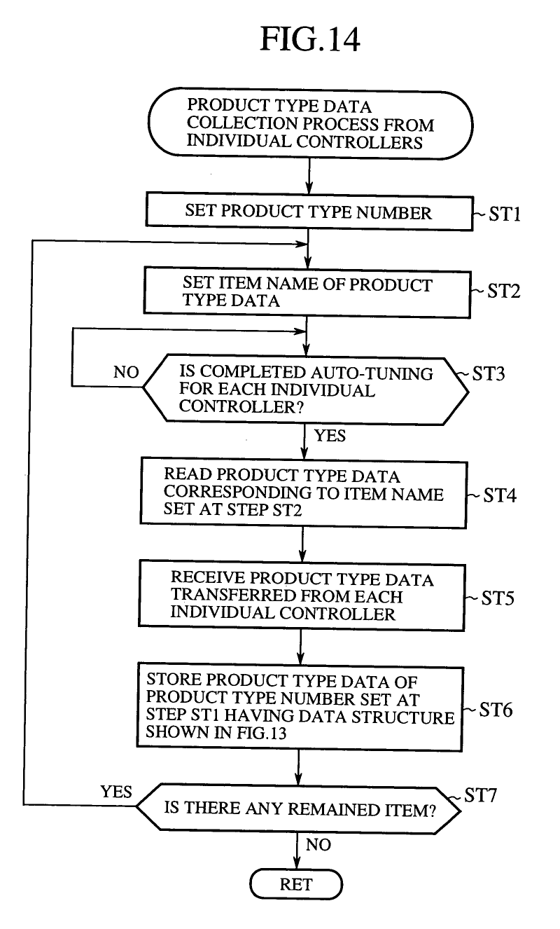

As shown in FIG. 13, the product type data 125, 126 are classified every product type and stored in the product type data storage means 113. Each product type data is composed of P (Proportion) value, I (Integral) value, D (Differential) value, and SP(Set Parameter) value.

Next, a description will now be given of the operation of the product type data management apparatus.

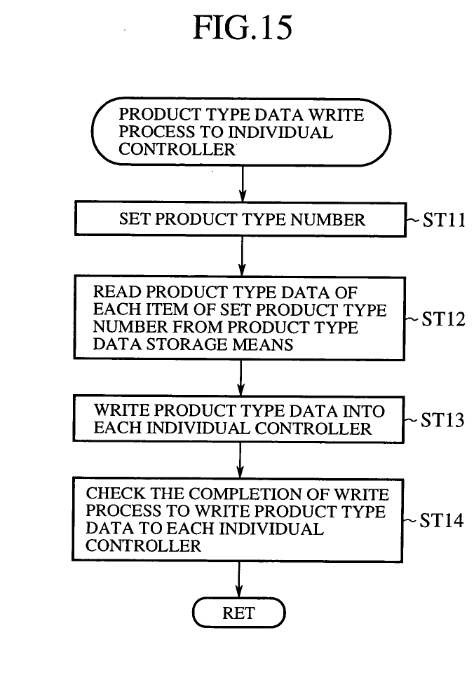

FIG. 14 is a flow chart showing the operation of the product type data management apparatus 1.01 in the product type data management system to read the product type data adjusted by the auto-tuning from each individual controller 104, 105, . . . , and 106 and to collect them through the communication line 107. FIG. 15 is a flow chart showing the operation of the product type data management apparatus 101 to write the product type data stored in the product type data storage means 113 into the individual controllers 104, 105, . . . , and 106.

First, the collection operation of the product type data by the product type data management apparatus 101 will be explained according to the flowchart shown in FIG. 14.

In such a collection of the product type data, the product number corresponding to the product type of bread is inputted through the input means 103 in the product type data management apparatus 101 (Step ST1). This product type number becomes the number 1 when the product type of bread is croissant (or crescent roll), becomes the number 2 when it is white bread, becomes the number 3 when it is crumb bun. Thus, those product type numbers are determined in advance.

Next, through the input means 103, the operator sets one of the item names such as P(Proportional) value, I(Integral) value, D(Differential) value, and SP(Set Parameter) value for use in the temperature control of each part in the oven where the bread according to the product type set at Step ST1 is baked (Step ST2). In this case, each individual controller 104, 105, . . . , and 106 controls the temperature of each part in the oven so that the bread is baked under the best condition, and each individual controller stores P (Proportion) value, I (Integral) value, and D (Differential) value, and SP value of the product type obtained by auto-tuning.

It is judged whether or not the auto-tuning for each part in the oven is completed by each of the individual controllers 104, 105, and 106 (Step ST3).

If it is not completed, the following process is waited until the completion of the auto-tuning.

On the other hand, when the auto-tuning has been completed, the product type data readout means 124 reads the product type data such as P value, for example, which is the item set at Step ST2, from the individual controllers 104, 105, . . . , and 106 through the communication line 107 (Step ST4), and then receives the product type data.

The received product type data regarding the name of the item are stored with the format shown in FIG. 13 into the product type data storage means 113 (Step ST6).

Next, it is checked whether there is any item remained (Step ST7). In the case above, because P (Proportion) value, I (Integral) value, D (Differential) value, and SP (Set Parameter) value are remained because those items are not selected in Step ST2, the process is returned to Step ST2. The operator inputs the name of the item I (Integral) through the input means 103. The processes of Step ST2 to Step ST7 are executed for the item I. The product type data read are stored in the product type data storage means 113 in the formats of the product type data shown in FIG. 13. Those processes are repeated for all the items remained.

When there is a request to collect the product type data of another product type, the product type number corresponding to the product type is set at Step ST1. The processes of Step ST2 to Step ST7 are then performed. In this case, the following conditions are satisfied: The bread of the product type corresponding to the product type number set at Step ST1 is now baked in the oven; Each of the individual controller 104, 105, . . . , and 106 controls the temperature of each part in the oven so that the bread of the product type is baked in the best state; and Each of the individual controllers 104, 105, and 106 calculates and keeps P (Proportion) value, I (Integral) value, D (Differential) value, and SP (Set Parameter) value regarding the product type by auto-tuning function.

The above processes are the process of reading the product type data by setting the name of the item of the product type data. However, because the items of the product type data registered into the product type data storage means are defined in advance, it is possible to read all of the items by performing Steps ST1, and ST3-ST6 shown in FIG. 14. In this procedure, Steps ST2 and ST7 are not executed.

Thus, the individual controllers 104, 105, and 106 collect P (Proportion) value, I (Integral) value, D (Differential) value, and SP (Set Parameter) value for all of the product types as product type data 125, 126, . . . . Those values are stored into the product type data storage means 113 per product type number corresponding to the product type, as shown in FIG. 13.

Next, a description will now be given of the write-in operation of the product type data into the individual controllers 104, 105, . . . , and 106 with reference to the flow chart shown in FIG. 15.

In the write-in process of such a product type data, first, the product type number is inputted through the input means 103 in the product type data management apparatus 101 (Step ST11).

When the product type number is inputted and set, the product type data readout means 124 reads the product type data based on the product type number inputted and set, from the product type data items 125, 126, . . . , which are stored every product type number in the product type data storage means 113 shown in FIG. 13 (Step ST12).

Next, the control means 111 in the product type data management apparatus 101 writes the product type data into each of the individual controllers 104, 105, . . . , and 106 using the communication means 114 through the communication line 107 (Step ST13). Then, when receiving a response transferred from each of the individual controllers 104, 105, . . . , and 106, the control means 111 in the product type data management apparatus 101 recognizes the completion of the writing process of the product type data in each individual controller (Step ST14).

In the explanation described above, although each of the individual controllers 104, 105, . . . , and 106 controls the temperature of each part in the oven, the present invention is not limited by this case using the oven and the temperature as a physical quantity to be controlled. For example, it is possible to apply the concept of the present invention to all values as the object of the automatic control.

As described above according to the second embodiment, because the product type data management apparatus 101 reads and collects each value of P (Proportion) value, I (Integral) value, D (Differential) value, and SP(Set Parameter) value of each product type, adjusted by auto-tuning in each of the individual controllers 104, 105, . . . , and 106, through the communication line 107, it is possible to eliminate the work to collect and input those data, P (Proportion) value, I (Integral) value, D (Differential) value, and SP (Set Parameter) value. On the contrary, the prior technique requires collecting and inputting those data. Therefore the second embodiment has the effect that it is possible to register into the product type data management apparatus 101 correctly and rapidly each value in P (Proportion) value, I (Integral) value, D (Differential) value, and SP (Set Parameter) value determined by each of the individual controllers 104, 105, . . . , and 106.

Third Embodiment

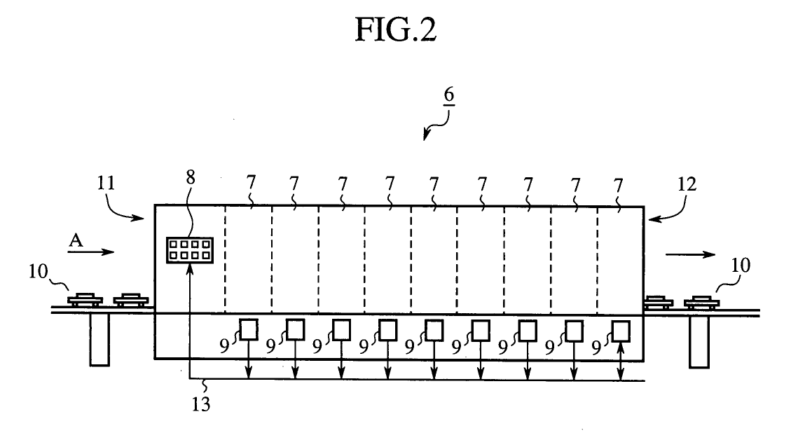

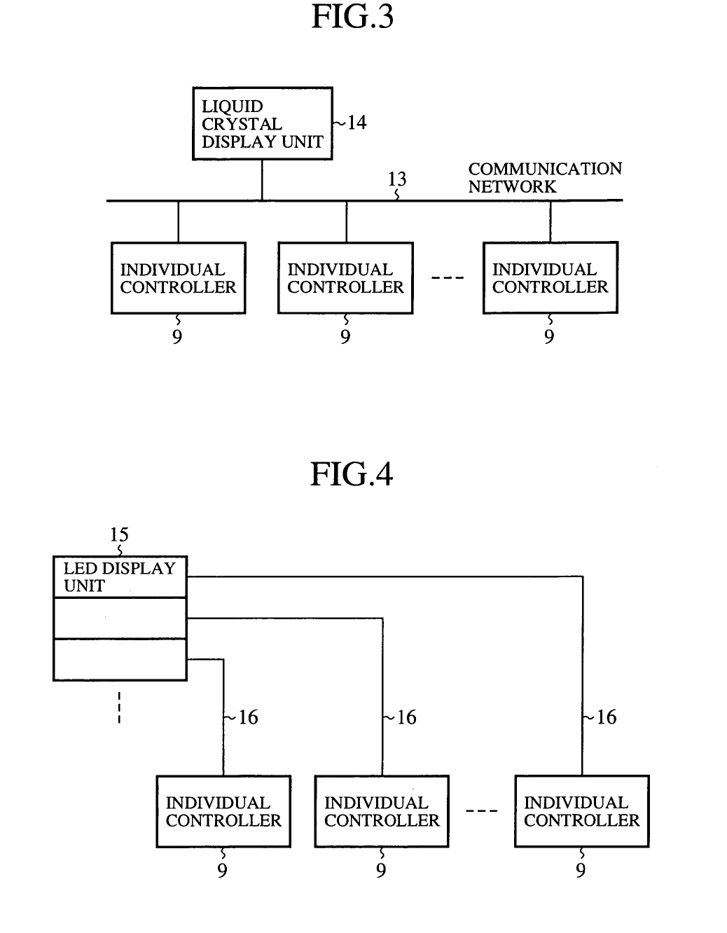

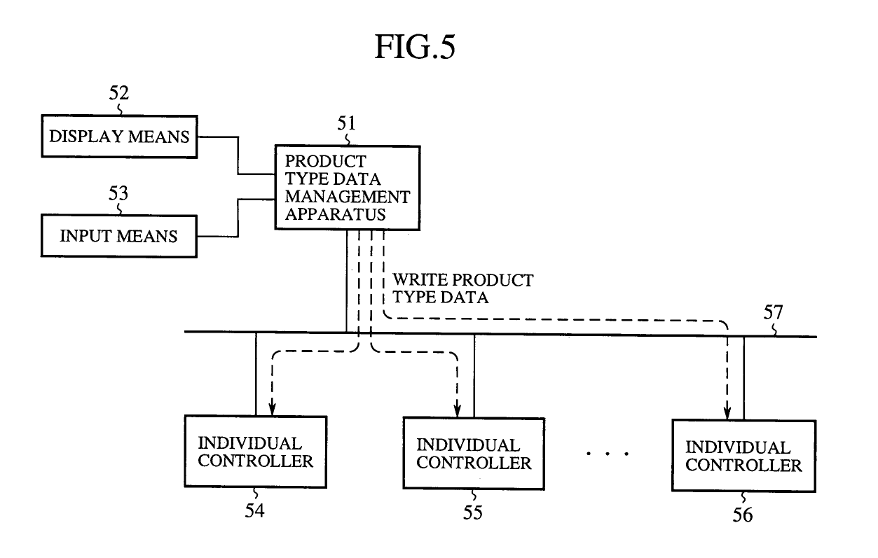

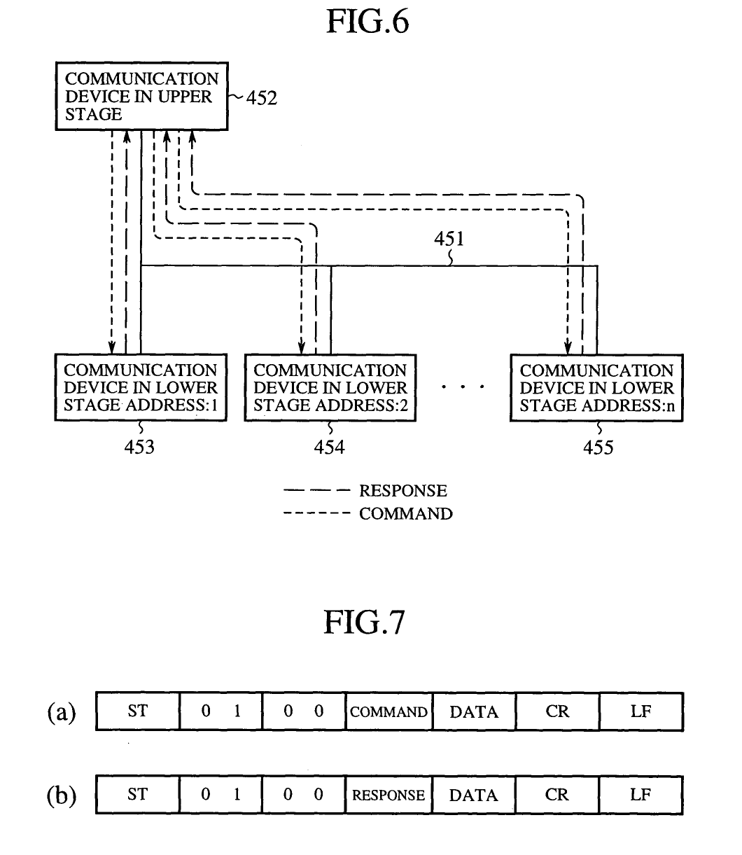

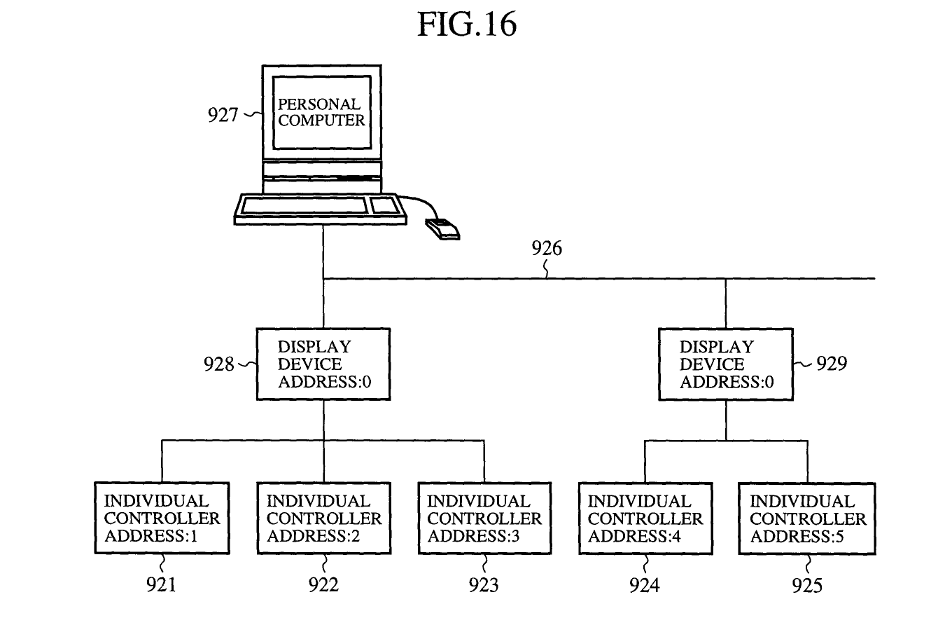

FIG. 16 is a block diagram showing a configuration of a communication system to which a communication relay device of the present invention is applied. In the diagram, reference number 921, 922, . . . , and 925 designate the individual controllers (as the communication devices in the lower stage) like the individual controllers assigned by the addresses 1 to 5 for controlling the high temperature furnaces such as the solder bathes, as shown in FIG. 2. Each individual controller has the same type of that shown in FIG. 10 in configuration. Reference number 926 designates a communication line made up of RS232C or RS485 and so on. Reference number 927 denotes a personal computer (as the communication device in the upper stage). Reference number 928 indicates a display device (as the communication relay device) assigned by address 0 placed at the intermediate position between the personal computer 927 and the individual controllers 924 and 925. The display devices 928 and 929 basically have the same configuration of the control unit 20 shown in FIG. 8.

Here, the address 0 means that the device has no address, namely, it is in the shipping state. In this case, the personal computer 927 cannot therefore recognize the communication relay devices 928 and 929, so that the personal computer 927 looks the configuration in which the individual controllers 921, 922, . . . , and 925 assigned by addresses 1 to 5 are directly connected to the communication line 926.

Next, a description will now be given of the operation of the communication system shown in FIG. 16.

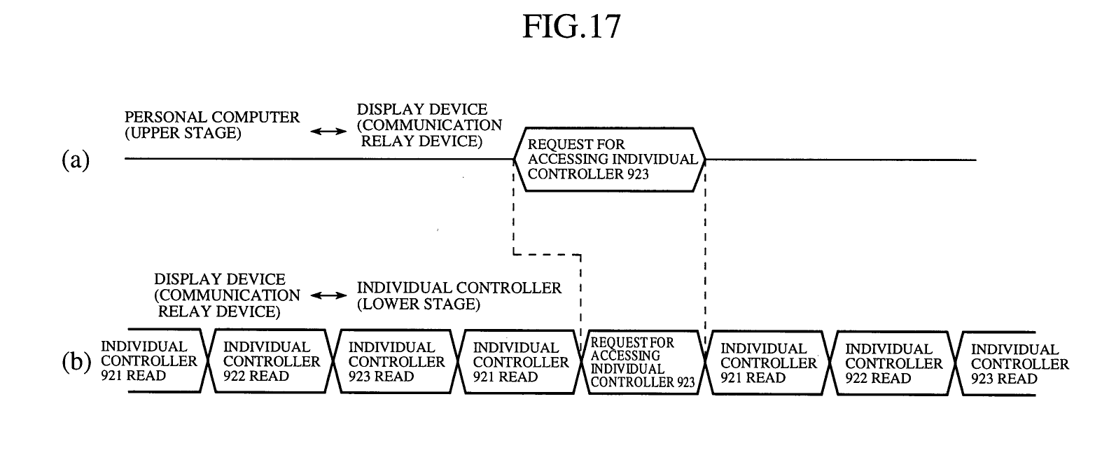

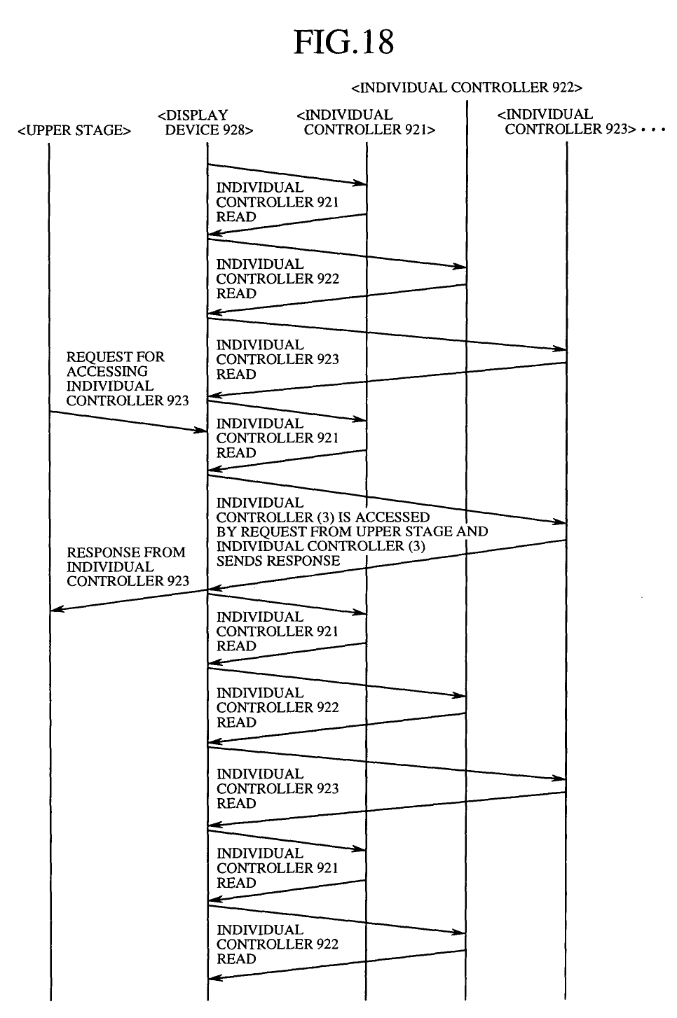

FIG. 17 is a diagram showing an example of communication data for use in the communication system. In FIG. 17, reference character (a) designates communication information transferred between the personal computer 927 in the upper stage and the display device 928 in the lower stage, and (b) indicates communication information transferred between the display device 928 and each of the individual controllers 921, 922, and 923. FIG. 18 is a diagram showing the transmission sequence of the communication information shown in FIG. 17.

The CPU 41 in the display device 928 accesses the individual controllers 921, 922, and 923 specified by the addresses 1 to 3 in order and transfers the commands (such as Individual controller 1 “READ”, Individual controller 2 “READ”, and the like) to read the data therein (for example, the temperature data measured). The CPU 41 then performs a routine to receive the response from the individual controllers and to extract the data included in the received response. The CPU 41 stores the received data into the memory 22 (see FIG. 8) and displays the data on the LED display unit 23 (see FIG. 8).

When receiving the request to access the specified individual controller (for example, the individual controller 923 specified by address 3), the display device interrupts the access to the following individual controller after the completion of the current access to the individual controller, and transfers the access request from the personal computer 927 to the individual controller specified by the access request. The display device then receives the response from the individual controller specified by the access request and transfers the response to the personal computer 927. In this case, when the response includes the data such as the temperature data measured and the like, the personal computer 927 copies (or stores) the data into the memory 22 and displays the data on the LED display unit 23.

Because the personal computer 927 transfers the data request command to the individual controller 923 specified and receives the response form the individual controller 923, the personal computer 927 does not recognize the presence of the display device 928 placed between the personal computer 927 and the individual controller 923, namely, the personal computer 927 can see that the individual controller 923 is directly connected to the communication line 926 without any recognition of the presence of the display device 928. Similarly, when transferring the data request command to the individual controllers 924 and 925, the personal computer 927 can see that the individual controllers 924 and 925 are directly connected to the communication line 926 without any recognition of the presence of the display device 929.

Thus, the display devices 928 and 929 as the communication relay device, each of which comprises the communication process means and additional function process means. When receiving the data request command transferred form the personal computer 927 as the communication device in the upper stage, the communication process means in each display device directly transfers the data request command to the individual controllers in the lower stage without any changing it. When receiving the response as communication information transferred form the individual controllers, the communication process means in each display device directly transfers the received response information to the personal computer 927 without any changing it. The additional function process means performs the display process as the additional function process based on the information included in the response, for example, the display data.

Accordingly, even if the display device 928 or 929 is placed between the personal computer 927 and the group of the individual controllers 921 to 923 or the group of the individual controllers 924 and 925, the personal computer 927 can communicate directly with the individual controllers 921, 922, . . . and 925 without any recognition of the presence of the display devices 928 and 929. Further, when specifying a desired individual controller in the controllers 921, 922, . . . , and 925 and transferring the data request command to the specified one, the personal computer 927 can receive the response from the specified individual controller. As a result, it is not necessary to change any program and the like in the personal computer 927. On the other hand, the display devices 928 and 929 can receive the response transferred from the individual controller and get the specified information such as the display data included in the response, and then perform the additional function process such as the display process for the display data.

As described above, according to the third embodiment, there is the effect to provide the display devices 928 and 929 as the communication relay device for relaying data, which can be incorporated as additional devices between the personal computer 927 and the individual controllers 928 and 929 forming the common communication system without any changing the configuration of the personal computer 927.

Further, in this case, the communication means in the display means 928 and 929 transfers the command to request the display data to the individual controllers 921, 922, . . . , and 925, and the additional function process means performs the display process as the additional function process based on the display data as the response, transferred from the individual controllers 921, 922, . . . , and 925, received by the communication process means. Accordingly, it is possible to obtain the effect where the display devices 928 and 929 as the communication relay device placed between the personal computer 927 and the individual controllers 921, 922, . . . , and 925 can independently transfer the data request command to the individual controllers 921, 922, . . . , and 925 in order to obtain the necessary response.

Still further, in this case, the additional function process means in the display devices 928 and 929 performs the additional function process to display the measured temperature data included in the display data transferred from the individual controllers 921, 922, . . . , and 925. Accordingly, when the display devices 928 and 929 are placed close to a furnace or a solder bath which is controlled by the individual controllers 921, 922, . . . , and 925, a field operator can directly check the measured temperature data of the higher temperature room such as the furnace or the solder bath. Therefore there is the effect that it is possible to adjust the temperature of each high temperature room by corresponding to the individual controller efficiently.

Still further, in this case, the communication process means in the display devices 928 and 929 performs the routine process where it transfers the command to request specified information to the plural individual controllers 921, 922, . . . , and 925 in order and receives the response form those controllers, and when receiving the data request command for a desired individual controller transferred from the personal computer 927, the display devices 928 and 929 interrupts the routine process in order to execute the communication process based on the data request command from the personal computer 927. Therefore there is the effect that the personal computer 927 can transfer the data request command to the desired individual controller and receives the response from the individual controller quickly without any recognition of the presence of the display devices 928 and 929 even if the display devices 928 and 929 perform the routine process to the individual controllers.

The third embodiment shows the configuration where the communication process means in the display devices 928 and 929 transfers the data request command from the personal computer in the upper stage to the individual controllers 921, 922, . . . , and 925 in the lower stage as the target of this data request command, and receives the response from the target individual controller, and then relays the response to the personal computer 927, and the display devices 928 and 929 perform the display process to display the measured temperature data, namely, the information transferred between the communication device in the upper stage and the devices in the lower stage and the specified information to be processed by the additional function process means in the display devices 928 and 929. However, the present invention is not limited by this configuration, that is, other than the data request command described above, the communication process means can relay commands which are transferred form the communication device in the upper stage to the communication devices in the lower stage.

That is, when receiving the communication information from the communication device in the upper stage, the communication process means in the communication relay device transfers this communication information to the communication devices in the lower stage. When receiving the response to the communication information from the communication devices in the lower stage, the communication process means transfers the response to the communication device in the upper stage. In this case, the level of the electric signal to be used in the communication with the communication device in the upper stage is equal in level to that in the communication with the communication devices in the lower devices. For example, when RS232C as the communication means (communication line 926) is used in the communication with the communication device in the upper stage, RS232C is also used in the communication with the communication device in the lower stage. Therefore the level of the electric signal is within the range of −12 Volts to +12 Volts. When RS485 is used in the communication with the communication device in the upper stage, RS485 is also used in the communication with the communication device in the lower stage. The level of the electric signal is within the range of 0 volt to +5 Volts.

Moreover, in the third embodiment, the additional function process means in the display devices 928 and 929 performs the data display function to display the measured temperature data. The present invention is not limited by this configuration. For example, it is possible that the additional function process means includes the diagnosis function for the communication devices of the lower stage to diagnose whether or not the communication devices of the lower stage are performing correctly or the data buffering function to store the data from the communication devices of the lower stage into the memory.

Fourth Embodiment

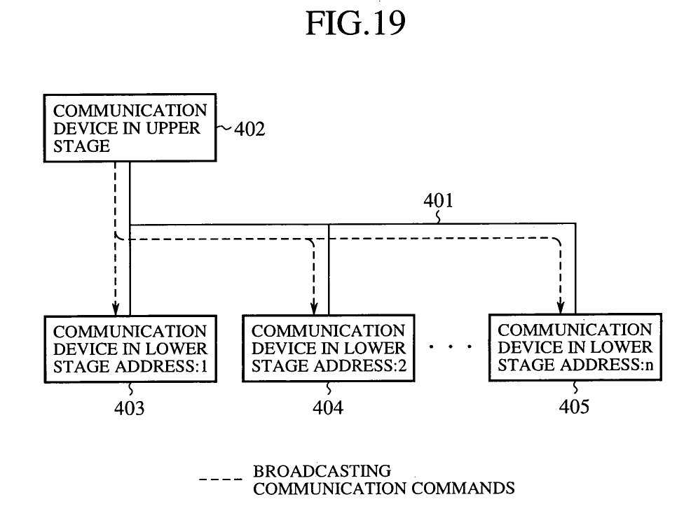

FIG. 19 is a block diagram showing a configuration of a broadcasting communication system according to a fourth embodiment of the present invention.

In the following explanation, the broadcasting communication means that the communication is performed between the communication devices in the upper stage and the lower stage, all of the communication devices of the lower stage receive the command transferred from the communication device of the upper stage simultaneously, and perform the content of the received command. Further, it is defined that the address for the broadcasting communication command different from the inherent address of the communication device of the lower stage or the command for the broadcasting communication is specified in the command, and when the address for the broadcasting communication command is specified, the all of the communication devices of the lower stage perform the content of the command received, and don't send any response to the communication device of the upper stage. In this case, this command is referred to as the broadcasting communication command.

In FIG. 19, reference number 401 designates a communication line wired in a factory, 402 denotes a communication device of the upper stage, 403, 404, . . . , and 405 indicate communication devices of the lower stage. The communication device of the upper stage 402 is connected to the communication devices of the lower stage 403, 404, . . . , and 405 though the communication line 401. The communication device of the upper stage 402 is a personal computer (hereinafter, also referred to as PC) and the communication devices 403, 404, . . . , and 405 are the devices, controlled by the communication device 402 of the upper stage, which are the same kind of the individual controller 9 prescribed having the communication function, for example, the temperature controller for use as the common controller

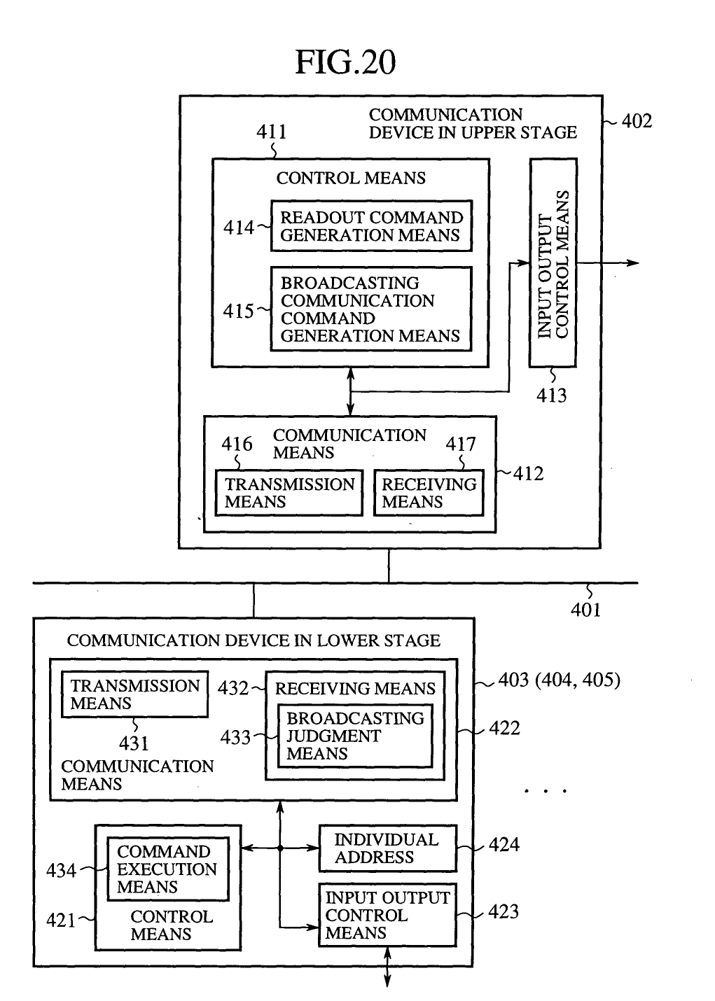

FIG. 20 is a block diagram showing a configuration of the communication device 402 of the upper stage and the communication device of the lower stage in the broadcasting communication system shown in FIG. 19.

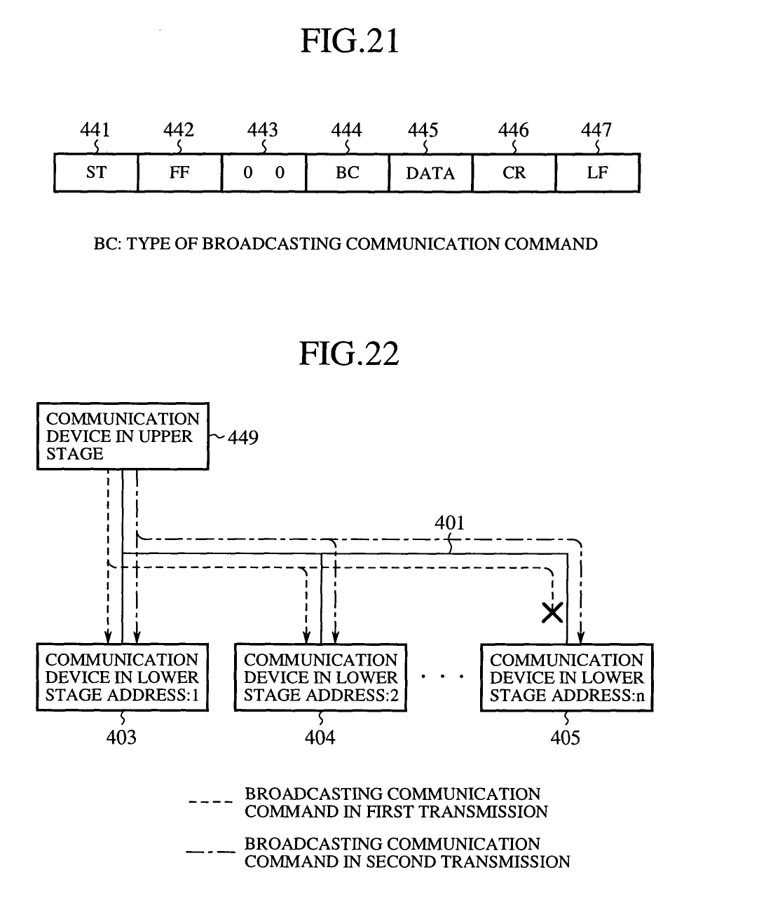

In FIG. 20, the same components of the configuration shown in FIG. 19 are referred with the same reference numbers and the explanation for them is omitted here. In FIG. 20, reference number 411 designates a control means in the communication device of the upper stage including a CPU, 412 denotes a communication means for performing the communication with the communication devices 403, 404, . . . , and 405 of the lower stage, and 413 indicates input output control means including various interfaces for performing data input and output processes to outside devices. Reference number 414 designates a command generation means for generating readout command to read new data items such as a control amount and an alarm from the communication devices 403, 404, . . . , and 405 of the lower stage. Reference number 415 indicates a broadcasting command generation means for generating a broadcasting communication command for use in the broadcasting communication. This broadcasting communication command generation means 415 generates the broadcasting communication command including an address for use in the broadcasting communication, the address is designated by reference number 442 shown in FIG. 21, by which the communication devices 403, 404, . . . , and 405 of the lower stage can judge that this communication is the broadcasting communication without any changing the inherent addresses. This inherent address is assigned in advance to the communication devices 403, 404, . . . , and 405 and used in the usual communication.

Reference number 416 designates a transmission means in the communication means 412 for performing the communication with the communication devices 403, 404, . . . , and 405 through the communication line 401. The transmission means 416 transfers the usual command including the inherent address specifying the communication device of the lower stage in order to communicate with the communication device of the lower stage specified by the inherent address. In addition to this, the transmission means 416 has the function to receive the broadcasting communication command transferred from the communication device of the upper stage, transfers the received one to all the communication devices 403, 404, . . . , and 405.

Reference number 417 denotes a receiving means for receiving a response from the communication device of the lower stage when the communication with the communication device specified.

Reference number 421 indicates a control means including a CPU incorporated in the communication devices 403, 404, . . . , and 405 of the lower stage. Reference number 422 denotes a communication means for communicating with the communication device 402 of the upper stage.

Reference number 423 designates an input output control means including various interfaces through which data are inputted from and outputted to outside devices. Reference number 424 denotes inherent addresses (stored in the memory) assigned to the communication devices of the lower stage. Reference number 431 indicates a transmission means in the communication means 422, which has the function to transfer the response to the communication device 402 of the upper stage in one-to-one communication. Reference number 432 designates a receiving means having the function to transfer a broadcasting communication command in addition to the normal command including the inherent address of the communication device of the lower stage various commands for use in the one-to-one communication between the communication devices of the upper stage and the lower stage. The communication device 402 of the upper stage transfers the broadcasting communication command to all the communication devices 403, 404, . . . , and 405 of the lower stage in order to perform the broadcasting communication. Reference number 433 indicates a broadcasting judgment means for judging whether or not the command transferred from the communication device 402 of the upper stage is the broadcasting communication command. Reference number 434 denotes a command execution means for executing the usual command including the inherent address transferred from the communication device 402 of the upper stage and the broadcasting communication command.

FIG. 21 is a diagram showing a format of the broadcasting communication command for use in the broadcasting communication. In FIG. 21, reference number 441 designates a start command, 442 denotes an address field in the broadcasting communication command. When including this address for the broadcasting communication command, it is judged that the command is the broadcasting communication command. Reference number 443 is a dummy field, 444 designates a kind field of the broadcasting communication command, 445 denotes data field according to the kind of the broadcasting communication command, and 446 and 447 denote completion codes.

Next, a description will now be given of the operation of the broadcasting communication system.

The inherent address 424 (stored in the memory) is assigned to each of the communication devices 403, 404, . . . , and 405 in the lower stage. When the communication device 402 of the upper stage performs the broadcasting communication to the communication devices 403, 404, . . . , and 405 of the lower stage, the broadcasting communication command generation means 415 generates the broadcasting communication command having the format shown in FIG. 21. The transmission means 416 then outputs the broadcasting communication command generated to the communication line 401. The receiving means 432 of each communication device of the lower stage receives the broadcasting communication command through the communication line 401. The broadcasting judgment means 433 in each communication device judges that this received command is the broadcasting communication command. The judgment whether or not it is the broadcasting communication command is performed by checking the address field 442 and the type field 444 in the broadcasting communication command.

When the received one is the broadcasting communication command, each communication device of the lower stage executes the content specified by the broadcasting communication command based on the data 445 according to the type of the broadcasting communication command recognized by command execution means 434 in the control means 421. In this case, namely in the broadcasting communication, the control means 421 in each the communication device of the lower stage does not send any response to the communication device 402 of the upper stage.

When the one-to-one communication is performed between the communication devices in the upper stage and the lower stage, the response having the configurations (a) and (b) shown in FIG. 7 is transferred between the communication device 402 of the upper stage and the communication devices 403, 404, . . . , and 405 in the upper stage.

When a demand to perform the broadcasting communication occurs during the one-to-one communication, the communication device 402 halts the operation of the usual communication, generates the broadcasting communication command immediately, as shown in FIG. 21, and outputs the generated one to the communication line 401. As a result, because the receiving means 432 in each communication device of the lower stage can judges that this command is the broadcasting communication command received, the control means 421 forcedly halts the operation to control the outside devices immediately, for example, in ordre to execute the content specified by the broadcasting communication command preferentially.

The content is indicated by the type 444, the data 445 and the like in the broadcasting communication command shown in FIG. 21. This content includes the halt and start of the operation of the communication device of the lower stage, and other instructions. In the broadcasting communication, each of the communication devices 403, 404, . . . , and 405 of the lower stage do not send any response to the communication device 402 of the upper stage.

As described above, according to the communication devices and the broadcasting communication system of the fourth embodiment, without any changing the inherent address assigned to each of the communication devices 403, 404, . . . , and 405 of the lower stage, it is possible to execute the content specified by the broadcasting communication command transferred from the communication device 402 of the upper stage. As a result, it is possible to switch the operation from the usual one-to-one communication between the communication device 402 of the upper stage and each of the communication devices 403, 404, . . . , and 405 of the lower stage to the broadcasting communication immediately. For example, there is the effect as follows: In the execution of the usual communication between the communication device 402 of the upper stage and each of the communication devices 403, 404, . . . , and 405 of the lower stage and in the monitoring of the control states and the alarm from the communication devices of the lower stage, the communication device 402 detects that a malfunction occurs in one communication device of the lower stage, and instructs to stop all of the communication devices of the lower stage, the communication device 402 of the upper stage can perform the broadcasting communication to all the communication devices of the lower stage in order to stop the operation of all the communication devices 403, 404, . . . , and 405 of the lower stage simultaneously.

Fifth Embodiment

FIG. 22 is a block diagram showing a configuration of a broadcasting communication system according to a fifth embodiment of the present invention. In FIG. 22, the same components of the configuration shown in FIG. 19 are referred with the same reference numbers and the explanation for them is omitted here. In the diagram, reference number 449 indicates a communication device of the upper having the function to send the broadcasting communication command to the communication devices 403, 404, . . . , and 405 of the lower stage sequentially and to receive the responses from them. Other configuration is the same of that of the communication device 402 of the upper stage according to the fourth embodiment.

Next, a description will now be given of the operation of the broadcasting communication system.

In the fifth embodiment, the communication device 449 of the upper stage sends the broadcasting communication command to the communication line 401 sequentially and plural times in the broadcasting communication. Therefore the possibility not to receive the broadcasting communication command by the communication device of the lower stage becomes small and it is thereby possible to increase the reliability of the broadcasting communication, because the communication device of the upper stage sends the broadcasting communication command sequentially and plural times even if one of the communication devices 403, 404, . . . , and 405 of the lower stage is in the malfunction state by noise and the like.

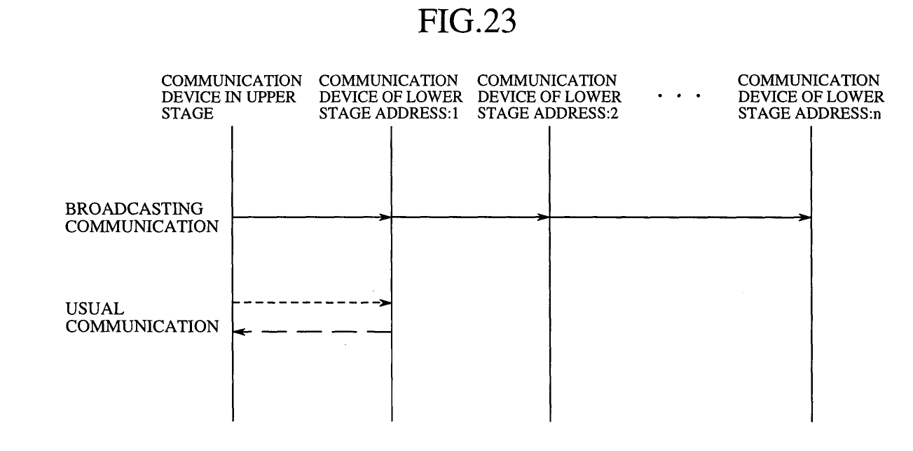

Further, as shown in the sequence diagram shown in FIG. 23, after the completion of the broadcasting communication, it is possible to switch the broadcasting communication to the one-to-one communication between the communication device 499 of the upper stage and the communication devices 403, 404, . . . , and 405 of the lower stage immediately.

It is thereby possible for the communication device 449 of the upper stage to easily and promptly judge whether or not each of the communication devices of the lower stage receives the broadcasting communication command correctly by reading and collecting the current value and the alarm information from the communication devices 403, 404, . . . , and 405 of the lower stage in the normal one-to-one communication, by checking the presence of the response from each of the communication devices 403, 404, . . . , and 405 of the lower stage, and by monitoring the malfunction of each of the communication devices 403, 404, . . . , and 405 of the lower stage.

As set forth, according to the communication devices and the broadcasting communication system according to the fifth embodiment, because the broadcasting communication commands are consequently sent plural times even if there occurs the state where one or more communication devices of the lower stage cannot receive the broadcasting communication command by noise and the like, it is possible to increase the reliability of the broadcasting communication. Further, by the communication devices and the broadcasting communication system, it is possible to promptly switch the current one-to-one communication to the broadcasting communication, or the current broadcasting communication to the one-to-one communication between the communication device 449 of the upper stage and the communication devices 403, 404, . . . , and 405 of the lower stage. Accordingly, it is possible to easily eliminate the drawback of the broadcasting communication by executing the usual communication immediately after the completion of the broadcasting communication, where the drawback of the broadcasting communication means that the communication device of the lower stage does not send any response to the communication device of the upper stage, so that the communication device of the upper stage cannot recognize whether or not the communication device of the lower stage has received the broadcasting communication command.

### INDUSTRIAL APPLICABILITY

As set forth, by using the display and control unit, the product type management device, the communication relay device, communication devices, and the broadcasting communication system according to the present invention, it is possible to provide the manufacturing facilities suitable for controlling the temperature, moisture, and other atmospheres in the making of the products using the manufacturing apparatus having complicated processes, for example, a furnace or an oven. Therefore because those devices of the present invention can provide simple and efficient factory facilities in the manufacture for many kinds of products, there is a large possibility of realization of the practical use of those devices.

What is claimed is:

1. A display and control unit comprising:
first communication means provided to each of a plurality of object control sections to be controlled, for reading detected data of the current state of each object control section and controlling each object control section into a set state;
controller selection means for selecting the individual controller to be controlled in a plurality of object control sections;
LED address display means for displaying the number and the address of the individual controller selected;
state display means for reading the data stored in the individual controller selected through the first communication means, and displaying the type of the data.

2. The display and control unit according to claim 1, wherein the object control sections have a plurality of state detection points, and individual controllers get detection data of the plural state detection points and have a function to control a set state of each state detection point, wherein
the display and control unit further comprises:
channel selection means for selecting a channel;
display means for displaying a number of the channel selected; and
LED state display means corresponding to the number of the channels.

3. The display and control unit according to claim 1, further comprises storage means for reading the detection data of the current state of each object control section from each individual controller at a desired cycle and for storing address display data and set data indicating the sets state of the individual controllers.

4. The display and control unit according to claim 1, further comprises second communication means for reading from storage means and transmitting address display data of the individual controllers, the detection data of the currently state, and set data of the set state according to a request from a computer that is placed at a remote location.

5. The display and control unit according to claim 1, wherein each individual controller has a function to set parameters of the set state in order to perform the operation per product type by a combination of the set state of each object control section,
wherein the display and control unit further comprises:
product set data making means for reading a plurality of data items by which each individual controller operates with the parameters, for making product set data for each product, and storing the product set data to the storage means; and
product selection means for reading the product set data from the storage means, and for transferring the read one to each individual controller.

6. A product type data management apparatus for managing product type data per product type by the individual controllers comprising:
product type number set means for setting the product type number corresponding to each type of the product;
product type data read means for communicating with the individual controllers and for reading the product type data of the products stored in the individual controllers;
product type data storage means for storing the product type data read from the individual controllers by the product type data read means according to the product type number set by the product type number set means.

7. The product type data management apparatus according to claim 6, wherein each individual controller has a controller having an auto-tuning function, and wherein the product type data including at least one of SP (Set Parameter), P(Proportional), I(Integral), and D(Differential) values.

8. A communication relay device to be placed between a communication device in upper stage and communication devices in lower stage, which comprising:
communication process means for transferring communication information to the communication devices in the lower stage without any changing it when receiving the communication information from the communication device in the upper stage, and for transferring communication information to the communication device in the upper stage without any changing it when receiving the communication information from the communication devices in the lower stage; and
additional function process means for performing an additional function process based on specific information included in the communication information when receiving the communication information from the communication devices in the lower stage.

9. The communication relay device according to claim 8, wherein the communication process means sends a command to request the specific information to the communication devices in the lower stage, and
the additional function process means performs the additional function process based on the response regarding the specific information from the communication devices in the lower stage received by the communication process means.

10. The communication relay device according to claim 8, wherein the additional function process means executes the additional function process to display the state of the communication devices in the lower stage included in the specific information.

11. The communication relay device according to claim 9, wherein the additional function process means executes the additional function process to display the state of the communication devices in the lower stage included in the specific information.

12. The communication relay device according to claim 8, wherein the communication process means executes a routine process in which the communication process means transfers a command to request the specific information to a plurality of the communication devices in the lower stage in serial order and a response transferred from them, and wherein
the communication process means interrupts the routine process in order to execute the communication process about the communication information when receiving this communication information transferred from the communication device in the upper stage to the communication devices in the lower stage.

13. A communication device as a host device for communicating with slave communication devices connected to the host communication device through a communication line, which comprising:
broadcasting communication command generation means for generating, when a broadcasting communication is performed, a broadcasting communication command including identification information which informs to the slave communication devices that this communication is the broadcasting communication, without any changing inherent addresses for use in usual communication, assigned to the slave communication devices in advance; and
transmission means for outputting the broadcasting communication command generated by the broadcasting communication command generation means to the communication line.

14. A communication device as a slave device for communicating with a host communication device connected to the slave communication device through a communication line, which comprising:
broadcasting judgment means for judging whether or not the communication is the broadcasting communication based on identification information included in a broadcasting communication command outputted from the host communication device through the communication line without any changing an inherent address set to the slave communication device for usual communication; and
control means for performing a process corresponding to the broadcasting communication command and prohibiting to output any response to the host communication device when the broadcasting judgment means judges that this communication is the broadcasting communication.

15. A broadcasting communication system comprising a host communication device and slave communication devices, in which the host communication device performs a broadcasting communication to the slave communication devices through a communication line, wherein
the host communication device comprises:
broadcasting communication command generation means for generating a broadcasting communication command including identification information which informs to the slave communication devices that this communication is the broadcasting communication, without any changing inherent addresses for use in usual communication, assigned to the slave communication devices in advance; and
transmission means for outputting the broadcasting communication command generated by the broadcasting communication command generation means to the communication line, and
the slave communication device comprises:
broadcasting judgment means for judging whether or not the communication is the broadcasting communication based on identification information included in the broadcasting communication command outputted from the host communication device through the communication line without any changing an inherent address set to the slave communication device for usual communication; and
control means for performing a process corresponding to the broadcasting communication command and prohibiting to output any response to the host communication device when the broadcasting judgment means judges that this communication is the broadcasting communication.

16. The communication device or the broadcasting communication system according to claim 13, wherein the transmission means in the host communication device continuously outputs the broadcasting communication command generated by the broadcasting communication command generation means to the communication line many times.

17. The broadcasting communication system according to claim 15, wherein the transmission means in the host communication device continuously outputs the broadcasting communication command generated by the broadcasting communication command generation means to the communication line many times.
